(19) United States
(12) Patent Application Publication
(10) Pub. No.: US 2009/0037106 A1
(43) Pub. Date: Feb. 5, 2009

(54) Collaborative GPS/INS system and method

(75) Inventors: Alexei Gavriline, Toronto (CA); Mamdouh Yanni, Markham (CA); Yang Gao, Calgary (CA); Yufeng Zhang, Calgary (CA)

Correspondence Address: Destinator Technologies, Inc., 95 Mural Street, 6th Floor, Richmond Hill, ON, L4B 3G2, CA

(73) Assignee: Destinator Technologies, Inc.

(21) Appl. No.: 11/974,391

(22) Filed: Oct. 11, 2007

Related U.S. Application Data
(60) Provisional application No. 60/920,241, filed on Mar. 26, 2007.

(51) Int. Cl. G01C 21/00

(52) U.S. Cl. 701/216

(57) ABSTRACT

A real-time integrated Global Positioning System (GPS) and Inertial Navigation System (INS) system in which each aids the other to offer continuously available navigation information by each GPS and INS subsystem calculating an initial solution, providing the initial solution to the other GPS or INS subsystem, and then each GPS and INS subsystem calculating a collaborative solution based on the initial solution received from the other GPS or INS subsystem.

### CROSS-REFERENCES

This U.S. nonprovisional patent application claims priority to and the benefit of U.S. provisional patent application No. 60/920,241 filed Mar. 26, 2007 and entitled “Continuous Navigation System” which is hereby incorporated by reference herein.

### BACKGROUND

1. Field of the Invention

The present invention is generally related to positioning and navigational systems and more specifically to integrated Global Positioning System (GPS) and Inertial Navigation System (INS) systems.

2. Related Art

GPS is a well-known satellite-based, all weather, line-of-sight radio navigation and positioning system funded and controlled by the U.S. Department of Defense. It is nominally formed from a constellation of 24 satellites and their ground stations. There are six orbital planes, spaced sixty degrees apart, and inclined at about fifty-five degrees with respect to the equatorial plane.

The concept of positioning with GPS is based on simultaneous ranging to a minimum of four GPS satellites from a GPS receiver. With known satellite coordinates, four-dimensional coordinates of the GPS receiver position can be determined. These include three spatial parameters in the X, Y and Z coordinate directions, and the receiver clock offset, δ T.

GPS satellites continuously transmit microwave carrier signals on two frequencies: L1 at 1575.42 MHz, and L2 at 1227.60 MHz. These signals are modulated with one or two pseudorandom noise (PRN) sequences known as the Course Acquisition (C/A) code and the Precise (P) code. The chipping frequencies of these signals are 1.023 MHz and 10.23 MHz, corresponding to chip lengths of approximately 300 m and 30 m, respectively. Both the C/A code and the P code modulate the L1 carrier, while the L2 carrier is only modulated by the P code. A 50 Hz navigation message is also modulated on the signals, which consists of data bits that describe the GPS satellite orbits, clock corrections, and other system parameters such as satellite health.

If the GPS receiver is unable to receive signals from a minimum of four satellites at a given instant, it will be unable to calculate a 3D position. This GPS outage situation often occurs when the GPS satellites are blocked by physical obstacles, including urban environments such as buildings. When this occurs, the GPS receiver user receives no navigation information. To prevent such situations, additional sensors have been used to assist GPS receivers to provide continuous navigation information during periods of GPS outages.

As a longstanding and well-known form of a dead reckoning system, INS uses an initial known position plus the output of inertial sensors to determine the position change of an object. INS systems are independent, fully self-contained navigation systems and while the accuracy of INS systems degrades over time due to uncompensated errors in its sensors, they are capable of accurate 3D positioning for a short period of time. These systems have been used extensively to assist with GPS systems to provide continuous navigation information during periods of GPS outages. Further, when there is no GPS outage, the GPS navigation information can be used to assist the INS to calibrate and compensate for its sensor errors.

An INS can consist of one or a combination of multiple inertial sensors. These sensors include an Inertial Measurement Unit (IMU), typically consisting of three gyros to measure the rotation and three accelerometers to measure acceleration along the x, y and z axes, a compass, an altimeter, a speedometer, and/or an odometer.

Most existing integrated GPS/INS systems perform integration using either loosely coupled or tightly coupled methods. For the loosely coupled approach, the GPS and INS systems are treated as separate or black-box navigation systems whereby the internal details of the systems are unknown to the integrator. The GPS system processes its raw GPS observables using its own proprietary filter/algorithm to output a navigation solution usually consisting of a position, velocity and time. The INS system processes its raw inertial measurements using its own proprietary filter/algorithm to output a navigation solution usually consisting of a position, velocity and attitude. An external, custom filter of the integrator then combines the GPS and INS solutions to generate a final navigation solution. The primary advantage of this method is simplicity, as any two GPS and INS systems can be easily integrated without the integrator having to know the implementation details of each individual GPS and INS system. The disadvantage is the sub-optimality of its integrated solution and the valid position solutions may not be continuous when there are GPS outages because the number of visible GPS satellites is less than four.

On the other hand, the tightly coupled integration approach utilizes the raw GPS observables and the raw inertial INS measurements which are operated on by a single custom filter to generate a single navigation solution. The advantage of the tightly coupled method is the optimality of the integrated solution and valid position solutions are available even when there are GPS outages because the number of visible GPS satellites is less than four. Its disadvantage is that the GPS and INS systems are simply treated as data acquisition systems thus requiring a complicated integration algorithm and, further, the positioning function and capability of the individual systems is not even utilized. Further, it is also often not even possible for an integrator to know the details of a given GPS or INS implementation, which are often proprietary, and therefore, for some GPS and INS systems, the tightly coupled approach cannot be used by the integrator at all.

What is needed, therefore, is an improved integrated GPS/INS system that has the advantages of both the loosely coupled and tightly coupled approaches without the disadvantages of either.

### SUMMARY

Various embodiments of the invention include a GPS or INS subsystem configured to calculate an initial solution, receive an initial solution from another GPS or INS subsystem, and calculate a collaborative solution based on the received initial solution.

According to one embodiment, a method comprises calculating an initial INS solution in an INS subsystem, calculating an initial GPS solution in a GPS subsystem, sending the initial INS solution from the INS subsystem to the GPS subsystem, sending the initial GPS solution from the GPS subsystem to the INS subsystem, calculating a collaborative INS solution in the INS subsystem, calculating a collaborative GPS solution in the GPS subsystem, outputting the collaborative INS solution from the INS subsystem, and outputting the collaborative GPS solution from the GPS subsystem.

According to another embodiment, a method comprises calculating an initial INS solution in an INS subsystem, calculating an initial GPS solution in a GPS subsystem, sending the initial INS solution from the INS subsystem to the GPS subsystem, sending the initial GPS solution from the GPS subsystem to the INS subsystem, outputting the initial INS solution from the INS subsystem, if the INS subsystem does not receive the initial GPS solution from the GPS subsystem, outputting the initial GPS solution from the GPS subsystem, if the GPS subsystem does not receive the initial INS solution from the INS subsystem, calculating a collaborative INS solution in the INS subsystem and outputting the collaborative INS solution from the INS subsystem, if the INS subsystem does receive the initial GPS solution from the GPS subsystem, and calculating a collaborative GPS solution in GPS subsystem and outputting the collaborative GPS solution from the GPS subsystem, if the GPS subsystem does receive the initial INS solution from the INS subsystem.

According to a third embodiment, an apparatus comprises an INS subsystem configured to calculate an initial INS solution, a GPS subsystem configured to calculate an initial GPS solution, the INS subsystem further configured to send the initial INS solution to a GPS subsystem, and still further configured to calculate and output a collaborative INS solution based on an initial GPS solution received from the GPS subsystem, and the GPS subsystem further configured to send the initial GPS solution to the INS subsystem, and still further configured to calculate and output a collaborative GPS solution based on the initial INS solution received from the INS subsystem.

According to a fourth embodiment, an apparatus comprising an INS subsystem configured to calculate an initial INS solution, a GPS subsystem configured to calculate an initial GPS solution, the INS subsystem further configured to send the initial INS solution to the GPS subsystem, and still further configured to calculate and output a collaborative INS solution if the INS subsystem receives an initial GPS solution from the GPS subsystem else output the initial INS solution, and the GPS subsystem further configured to send the initial GPS solution to the INS subsystem, and still further configured to calculate and output a collaborative GPS solution if the GPS subsystem receives the initial INS solution from the INS subsystem else output the initial GPS solution.

### BRIEF DESCRIPTION OF THE DRAWINGS

FIG. 1 is a functional block diagram of an exemplary collaborative GPS/INS system constructed in accordance with various embodiments.

FIG. 2 is a flowchart of an exemplary collaborative GPS/INS method according to various embodiments.

FIG. 3 is a trajectory map of a drive test performed according to various embodiments.

### DETAILED DESCRIPTION

The present invention is a system and method of collaboration between a GPS subsystem and an INS subsystem. Note that the term INS subsystem as used herein generally refers to any INS system such as an INS/IMU, a Compass, or an Altimeter, or a combination of such systems, used to aid a GPS system. The collaboration method according to some embodiments is for each subsystem to follow a collaborative integration three-step process for every measurement epoch as follows:
1) an initial solution generation step;
2) an aiding step where the initial solution is communicated to another sub-system to be used as aiding information; and,
3) an update step where aiding information received from another subsystem is used to update the initial solution to form a collaborative solution.
   In this way, each subsystem generates an improved solution, the collaborative solution, based on its own initial solution aided by that of another subsystem.

In some embodiments, each subsystem communicates its initial solution as aiding information using a collaborative integration protocol. The collaborative integration protocol is a standard pre-defined protocol that enables sub-systems to communicate with and understand each another. This facilitates a “plug and play” capability thus enabling combinations of GPS and INS products from different manufacturers to be used seamlessly. However, it is not necessary to utilize this particular collaborative integration protocol for collaborative integration as other protocols common to GPS and INS systems, or even a custom protocol, may be used in its place.

The collaborative integration protocol according to some embodiments is a state-less and connection-less protocol. All messages are sent automatically by the source sub-system at regular preset intervals without knowledge of the number of or the status of other listening sub-systems. The protocol has a single message type, referred to herein as Collaborative Inertial and GPS Data (CIGD) that describes the source sub-system, describes the aiding information and also contains the aiding information. The CIGD message consists of multiple fields and is outputted as an ASCII string, with the fields separated by commas. The first field of each message contains the message type, while the last field contains a checksum that ensures the message is received without errors. The start of each string is denoted with a ‘$’, while the end of the message payload (but prior to the checksum field) is represented by a ‘*’.

This output format is similar to the data sentences found in the National Marine Electronics Association (NMEA) specifications that are widely used with GPS receivers and INS platforms. The checksum is also calculated using the NMEA algorithm, whereby all bytes between (but not including) the ‘$’ and ‘*’ values of the message string are exclusive-OR'ed (XOR'ed) to form a two digit hexadecimal value.

Table 1 below shows the CIGD message schema:

TABLE 1
CIGD Message Schema

| Field | Description | |
|---|---|---|
| 1 | Message type - value is always ‘CIGD’ | |
| 2 | Type of system. Currently valid values: | |
| | ‘0’ | GPS |
| | ‘1’ | INS |
| | ‘2’ | Other |
| 3 | Included aiding information - a binary string with a length of | |
| | 8 bits. The default value is ‘00000000’, where a ‘0’ | |
| | indicates the information is not available, while ‘1’ indicates | |
| | the information is available. | |
| | 1^{st} bit | If 3D position information is available |
| | 2^{nd} bit | If 3D velocity information is available |
| | 3^{rd} bit | If 3D attitude information is available |
| | 4^{th} bit | If position information in geographical |
| | | coordinates is available |
| | 5^{th} bit | If 3D position accuracy information is available |
| | 6^{th} bit | If 3D velocity accuracy information is available |
| | 7^{th} bit | If 3D attitude accuracy information is available |
| | 8^{th} bit | If position information in geographical |
| | | coordinates' accuracy information is available |
| 4 | Time - UTC time of message creation (this field can be set to | |
| | 0 if the value does not exist) | |
| 5-28 | ‘POSX’ | Position in X axis (meters) |
| | ‘POSY’ | Position in Y axis (meters) |
| | ‘POSZ’ | Position in Z axis (meters) |
| | ‘VELX’ | Velocity in X axis (m/s) |
| | ‘VELY’ | Velocity in Y axis (m/s) |
| | ‘VELZ’ | Velocity in Z axis (m/s) |
| | ‘HEAD’ | Heading in decimal degrees, starting from |
| | | North and going clockwise |
| | ‘PITCH’ | Pitch in decimal degrees |
| | ‘ROLL’ | Roll in decimal degrees |
| | ‘LAT | Latitude in decimal degrees |
| | ‘LON’ | Longitude in decimal degrees |
| | ‘H’ | Height (meters) |
| | ‘SPOSX’ | Standard deviation of Position in X axis (meters) |
| | ‘SPOSY’ | Standard deviation of Position in Y axis (meters) |
| | ‘SPOSZ’ | Standard deviation of Position in Z axis (meters) |
| | ‘SVELX’ | Standard deviation of Velocity in X axis (m/s) |
| | ‘SVELY’ | Standard deviation of Velocity in Y axis (m/s) |
| | ‘SVELZ’ | Standard deviation of Velocity in Z axis (m/s) |
| | ‘SHEAD’ | Standard deviation of the Heading |
| | ‘SPITCH’ | Standard deviation of the Pitch |
| | ‘SROLL’ | Standard deviation of the Roll |
| | ‘SLAT’ | Standard deviation of Latitude in decimal degrees |
| | ‘SLON’ | Standard deviation of Longitude in decimal degrees |
| | ‘SH’ | Standard deviation of Height (meters) |

| | |
|---|---|
| 29 | Checksum |

The standard behavior of a sub-system is to broadcast the ‘CIGD’ message upon startup and after each measurement epoch where an initial solution (the solution before aiding) is obtained. After receiving the aiding information (an initial solution from another subsystem), each subsystem may utilize it in whatever manner it desires. Possible usage includes:
using aided position and velocity as additional measurements, enabling navigation output even in GPS outages;
using the aided quality information to weight measurements; and
using aiding information as a quality control check.

In general, the INS subsystem applies GPS solution aiding information to calibrate its biases and the GPS subsystem applying INS solution aiding information to improve GPS tracking and support navigation information output with less than four visible satellites. As such, an updated collaborative solution is generated in each subsystem based on initial solution aiding information received from another subsystem which collaborative solution is then output as navigation information. If no initial solution aiding information is provided from another subsystem, the initial solution is instead output as the navigation information.

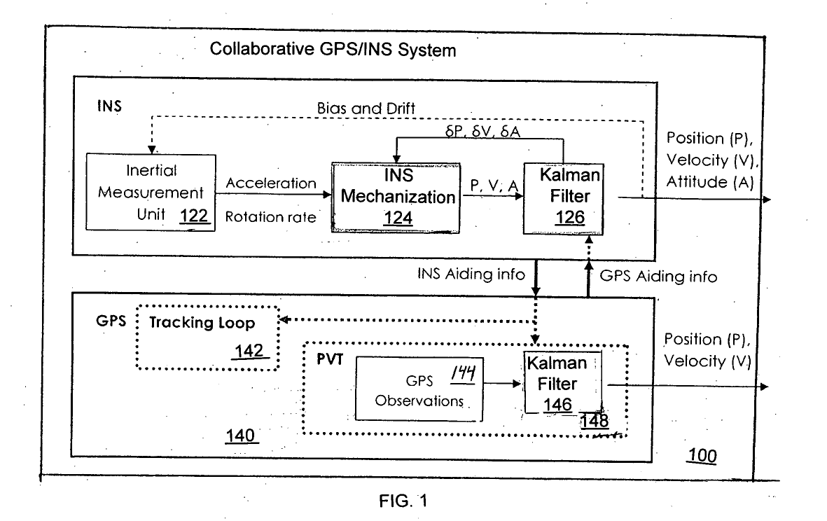

Referring now to FIG. 1, a functional block diagram of an exemplary collaborative GPS/INS system 100 constructed according to various embodiments is shown. There are two subsystems in the collaborative GPS/INS system 100, an INS subsystem 120 and a GPS subsystem 140. The INS subsystem 120 includes an IMU 122 which utilizes three accelerometers and three gyros to measure acceleration and rotation rates and a navigation algorithm for position, velocity and attitude determination. For the initial solution generation step, the navigation algorithm generates a continuously available navigation solution consisting of the position and velocity. The attitude is first calculated using the rotation information that comes from the gyros. Based on this attitude information, the velocity and the position can be determined by integrating the acceleration sensed by the accelerometers once and twice respectively. The position is provided in Cartesian coordinates in the Earth-Centered, Earth-Fixed (ECEF) frame. The velocity is provided in terms of velocities in the X, Y, Z axes of the ECEF frame. It is to be noted that the implementation details of such a navigation algorithm are known in the art. A variance-covariance matrix that provides the quality of the navigation solution is also generated and is part of the initial INS solution.

This initial INS solution is provided to aid other sub-systems. For example, the INS subsystem 120 is connected to the GPS subsystem 140 using a port (not shown), such as a serial port or a USB port. The initial INS solution is output from the INS subsystem 120 to the GPS-subsystem 140 using the ‘CIGD’ message type of the collaborative integration protocol and is communicated over the port at a certain frequency such as 1 Hz. The structure of the ‘CIGD’ message applicable to the INS subsystem 120 in one embodiment is seen in the following Table 2:

TABLE 2
CIGD Message Structure for INS Subsystem 120

| | |
|---|---|
| Field | Description |

| 1 | ‘CIGD’ | |
|---|---|---|
| 2 | ‘1’ | |
| 3 | ‘11001100’ | |
| 4 | UTC time | |
| 5-28 | ‘POSX’ | applicable |
| | ‘POSY’ | applicable |
| | ‘POSZ’ | applicable |
| | ‘VELX’ | applicable |
| | ‘VELY’ | applicable |
| | ‘VELZ’ | applicable |
| | ‘HEAD’ | not applicable |
| | ‘PITCH’ | not applicable |
| | ‘ROLL’ | not applicable |
| | ‘LAT | not applicable |
| | ‘LON’ | not applicable |
| | ‘H’ | not applicable |
| | ‘SPOSX’ | applicable |
| | ‘SPOSY’ | applicable |
| | ‘SPOSZ’ | applicable |
| | ‘SVELX’ | applicable |
| | ‘SVELY’ | applicable |
| | ‘SVELZ’ | applicable |
| | ‘SHEAD’ | not applicable |
| | ‘SPITCH’ | not applicable |
| | ‘SROLL’ | not applicable |
| | ‘SLAT’ | not applicable |
| | ‘SLON’ | not applicable |
| | ‘SH’ | not applicable |

| | |
|---|---|
| 29 | Checksum |

The initial INS solution provided by the INS subsystem 120 is the aiding information used by the GPS subsystem 140 to improve accuracies and support navigation information output when less than four satellites are visible.

As shown in FIG. 1, the GPS subsystem 140 includes a GPS receiver 142 which is embedded with a position, velocity and time (PVT) determination algorithm 148 that utilizes the GPS measurements to output an initial position and velocity solution. The position is provided in Cartesian coordinates in the ECEF frame. The velocity is provided in terms of velocities in the X, Y, Z axes of the ECEF frame. A variance-covariance matrix that provides the quality of the solution is also generated. This initial GPS solution, comprising the position, velocity and variance-covariance matrix, is provided to aid other subsystems such as INS subsystem 120. It is to be noted that the implementation details of such a GPS receiver's PVT algorithm 148 are known in the art. Note that a stand-alone GPS system is not generally able to provide continuous navigation solutions with less than four visible satellites. Therefore in such situations with less than four visible satellites, the GPS subsystem 140 can only output a navigation solution if it is aided with initial solution information from another subsystem such as INS subsystem 120.

This initial GPS solution is provided to aid other subsystems, for example INS subsystem 120. In this example, the GPS subsystem 140 is connected to the INS subsystem 120 using a port (not shown), such as a serial port or a USB port. The initial GPS solution is sent using the ‘CIGD’ message type of the collaborative integration protocol and is communicated over the port at a certain frequency such as 1 Hz. The structure of the ‘CIGD’ message applicable to the GPS subsystem 140 in one embodiment is seen in the following Table 3:

TABLE 3
CIGD Message Structure for GPS Subsystem 140

| | |
|---|---|
| Field | Description |

| 1 | ‘CIGD’ | |
|---|---|---|
| 2 | ‘0’ | |
| 3 | ‘11001100’ | |
| 4 | UTC time | |
| 5-28 | ‘POSX’ | applicable |
| | ‘POSY’ | applicable |
| | ‘POSZ’ | applicable |
| | ‘VELX’ | applicable |
| | ‘VELY’ | applicable |
| | ‘VELZ’ | applicable |
| | ‘HEAD’ | not applicable |
| | ‘PITCH’ | not applicable |
| | ‘ROLL’ | not applicable |
| | ‘LAT | not applicable |
| | ‘LON’ | not applicable |
| | ‘H’ | not applicable |
| | ‘SPOSX’ | applicable |
| | ‘SPOSY’ | applicable |
| | ‘SPOSZ’ | applicable |
| | ‘SVELX’ | applicable |
| | ‘SVELY’ | applicable |
| | ‘SVELZ’ | applicable |
| | ‘SHEAD’ | not applicable |
| | ‘SPITCH’ | not applicable |
| | ‘SROLL’ | not applicable |
| | ‘SLAT’ | not applicable |
| | ‘SLON’ | not applicable |
| | ‘SH’ | not applicable |

| | |
|---|---|
| 29 | Checksum |

The initial GPS solution provided by the GPS subsystem 140 is the aiding information used by the INS subsystem 120 to calibrate its sensors and account for their errors.

Focusing now on the INS subsystem 120, if no aiding information (i.e., no initial GPS solution) is received from the GPS subsystem 140, then the initial INS solution is output as navigation information and no collaborative integration occurs. Conversely, if aiding information (i.e., initial GPS solution) is received, then the INS subsystem 120 will utilize the aiding information in the update step to improve upon the initial INS solution and output the improved solution (referred to herein as the collaborative INS solution).

For the update step in one embodiment, a Kalman filter 126 is used within the INS subsystem 120 for position, velocity and attitude determination. A Kalman filter is a process for optimally estimating the error state of a system from its measurements and providing a variance covariance matrix describing the current knowledge of the error state. A Kalman filter features two phases, prediction and update. The prediction phase generates an estimate of the state at the next epoch. The update phase uses the new measurement information of the current epoch to update and improve upon the predicted estimate.

For collaborative integration of the INS subsystem 120 position and velocity (P_{I} and V_{I}), with the aiding position and velocity from the GPS sub-system (P_{G} and V_{G}), the following observation model is used for the INS subsystem 120 Kalman filter 126 update:

$$[ \begin{matrix}{P}_{G} - {P}_{I} \\ {V}_{G} - {V}_{I}\end{matrix} ] = [ \begin{matrix}- I & 0 & 0 & 0 & 0 \\ 0 & - I & 0 & 0 & 0\end{matrix} ] [ \begin{matrix}δ p \\ δ V \\ ɛ \\ {b}_{a} \\ {b}_{g}\end{matrix} ]$$

where δP denotes 3D position error vector; δV denotes 3D velocity error vector; ε denotes misalignment error vector; bₐ denotes accelerometer bias vector; b_{g} denotes gyroscope bias vector; The variance-covariance matrix R associated with the observation model is taken from the aiding GPS solution variance-covariance matrix.

Now looking at the GPS subsystem 140, if no aiding information (i.e., initial INS solution) is received from the INS subsystem 120, then the initial GPS solution is output as navigation information and no collaborative integration occurs. Conversely, if aiding information (i.e., an initial INS solution) is received, then the GPS subsystem 140 will utilize the additional information in the update step to improve upon the initial GPS solution and output the improved solution (referred to herein as the collaborative GPS solution).

For the update step in one embodiment, a Kalman filter 146 is also used within the GPS subsystem 140 for position, velocity and time determination. For collaborative integration of the GPS subsystem 140 position and velocity (P_{G} and V_{G}), with the aiding position and velocity from the INS sub-system (P_{I} and V_{I}), the following observation model is used for the GPS subsystem 140 Kalman filter 146 update:

$$[ \begin{matrix}d ρ \\ d \dot{ρ} \\ {P}_{G} - {P}_{I} \\ {V}_{G} - {V}_{I}\end{matrix} ] = [ \begin{matrix}\frac{\partial ρ}{\partial P} & 0 & \frac{\partial ρ}{\partial dt} & 0 \\ \frac{\partial \dot{ρ}}{\partial P} & \frac{\partial \dot{ρ}}{\partial V} & 0 & \frac{\partial \dot{ρ}}{\partial d \dot{t}} \\ - I & 0 & 0 & 0 \\ 0 & - I & 0 & 0\end{matrix} ] [ \begin{matrix}δ P \\ δ V \\ d t \\ d \dot{t}\end{matrix} ]$$

$$where$$

$$\frac{\partial ρ}{\partial P} = {[ \begin{matrix}\frac{\partial ρ}{\partial {X}_{r}} \\ \frac{\partial ρ}{\partial {Y}_{r}} \\ \frac{\partial ρ}{\partial {Z}_{r}}\end{matrix} ]}^{T} and \frac{\partial ρ}{\partial {X}_{r}} = \frac{{X}_{r} - {X}_{s}}{ρ} , \frac{\partial ρ}{\partial {Y}_{r}} = \frac{{Y}_{r} - {Y}_{s}}{ρ} , \frac{\partial ρ}{\partial {Z}_{r}} = \frac{{Z}_{r} - {Z}_{s}}{ρ}$$

$$\frac{\partial \dot{ρ}}{\partial V} = {[ \begin{matrix}\frac{\partial \dot{ρ}}{\partial {V}_{{x}_{r}}} \\ \frac{\partial \dot{ρ}}{\partial {V}_{{y}_{r}}} \\ \frac{\partial \dot{ρ}}{\partial {V}_{{z}_{r}}}\end{matrix} ]}^{T} and \frac{\partial \dot{ρ}}{\partial {V}_{{x}_{r}}} = \frac{{X}_{r} - {X}_{s}}{ρ} , \frac{\partial \dot{ρ}}{\partial {V}_{{y}_{r}}} = \frac{{Y}_{r} - {Y}_{s}}{ρ} , \frac{\partial \dot{ρ}}{\partial {V}_{{z}_{r}}} = \frac{{Z}_{r} - {Z}_{s}}{ρ}$$

$$\frac{\partial \dot{ρ}}{\partial P} = {[ \begin{matrix}\frac{\partial \dot{ρ}}{\partial {X}_{r}} \\ \frac{\partial \dot{ρ}}{\partial {Y}_{r}} \\ \frac{\partial \dot{ρ}}{\partial {Z}_{r}}\end{matrix} ]}^{T} and$$

$$\frac{\partial \dot{ρ}}{\partial {X}_{r}} = \frac{{V}_{{x}_{r}} - {V}_{{x}_{s}}}{ρ} + \frac{{( {X}_{s} - {X}_{r} )}^{2} ( {V}_{{x}_{s}} - {V}_{{x}_{r}} )}{{ρ}^{3}} + \frac{( {X}_{s} - {X}_{r} ) ( {Y}_{s} - {Y}_{r} ) ( {V}_{{y}_{s}} - {V}_{{y}_{r}} )}{{ρ}^{3}} + \frac{( {X}_{s} - {X}_{r} ) ( {Z}_{s} - {Z}_{r} ) ( {V}_{{z}_{s}} - {V}_{{z}_{r}} )}{{ρ}^{3}}$$

$$\frac{\partial \dot{ρ}}{\partial {Y}_{r}} = \frac{{V}_{{y}_{r}} - {V}_{{y}_{s}}}{ρ} + \frac{{( {Y}_{s} - {Y}_{r} )}^{2} ( {V}_{{y}_{s}} - {V}_{{y}_{r}} )}{{ρ}^{3}} + \frac{( {X}_{s} - {X}_{r} ) ( {Y}_{s} - {Y}_{r} ) ( {V}_{{x}_{s}} - {V}_{{x}_{r}} )}{{ρ}^{3}} + \frac{( {Y}_{s} - {Y}_{r} ) ( {Z}_{s} - {Z}_{r} ) ( {V}_{{z}_{s}} - {V}_{{z}_{r}} )}{{ρ}^{3}}$$

$$\frac{\partial \dot{ρ}}{\partial {Z}_{r}} = \frac{{V}_{{z}_{r}} - {V}_{{z}_{s}}}{ρ} + \frac{{( {Z}_{s} - {Z}_{r} )}^{2} ( {V}_{{z}_{s}} - {V}_{{z}_{r}} )}{{ρ}^{3}} + \frac{( {X}_{s} - {X}_{r} ) ( {Z}_{s} - {Z}_{r} ) ( {V}_{{x}_{s}} - {V}_{{x}_{r}} )}{{ρ}^{3}} + \frac{( {Y}_{s} - {Y}_{r} ) ( {Z}_{s} - {Z}_{r} ) ( {V}_{{y}_{s}} - {V}_{{y}_{r}} )}{{ρ}^{3}}$$

$$\frac{\partial ρ}{\partial dt} = c ; \frac{\partial \dot{ρ}}{\partial d \dot{t}} = c$$

The subscript s denotes a satellite position or velocity and subscript r denotes the receiver position or velocity. dt denotes the receiver clock bias and dt denotes the receiver clock drift. ρ and \dot{ρ} denote the pseudorange and range rate; and dρ and d\dot{ρ} are the difference between the measured and true pseudoranges and range rates. c is the speed of light. In some embodiments, these true values are approximated by using the predicted position and velocity from the previous epoch and broadcast satellite positions.

The variance-covariance matrix R associated with the observation model is determined according to the accuracy of the GPS pseudorange and range rate measurements as well as the aiding initial INS solution variance-covariance matrix.

A low-cost single-frequency GPS receiver typically provides two measurements for each observed satellite: the GPS pseudorange and range rate. Six additional measurements are provided by the INS subsystem 120, in the form of the ECEF position and velocity. This additional set of measurements enables navigation information output from the GPS subsystem 140 even when fewer than four visible GPS satellites are available. The total number of measurements is equal to two times the number of satellites plus six or 2×(number of satellites)+6.

Note that although in this embodiment of INS subsystem 120 and GPS subsystem 140 each sends their aiding information synchronously and at the same time interval, this is not a requirement. Each subsystem can instead send their initial solution aiding information at their own frequency or even randomly, with INS based subsystems typically capable of sending aiding information at a much higher frequency than GPS based subsystems.

Note further that in this embodiment both the INS subsystem 120 and the GPS subsystem 140 will output a collaborative navigation solution after receiving an initial solution from the other subsystem. The two collaborative solutions are mathematically similar in value and accuracy because of the use of the same measurement information, as is evidenced by test results discussed elsewhere herein. In one embodiment, the GPS subsystem 140 is considered to be the primary system while the INS subsystem 120 acts as an aiding source, so therefore the collaborative GPS solution will be the output solution shown to a user. However, if a collaborative GPS solution is not available, then the embodiment will show the initial GPS solution to the user unless the initial GPS solution is not available in which case the embodiment will either show the initial INS solution to the user or simply not have a navigation solution for that epoch. Simple switching logic (not shown) can be included in collaborative GPS/INS system 100 to perform this functionality.

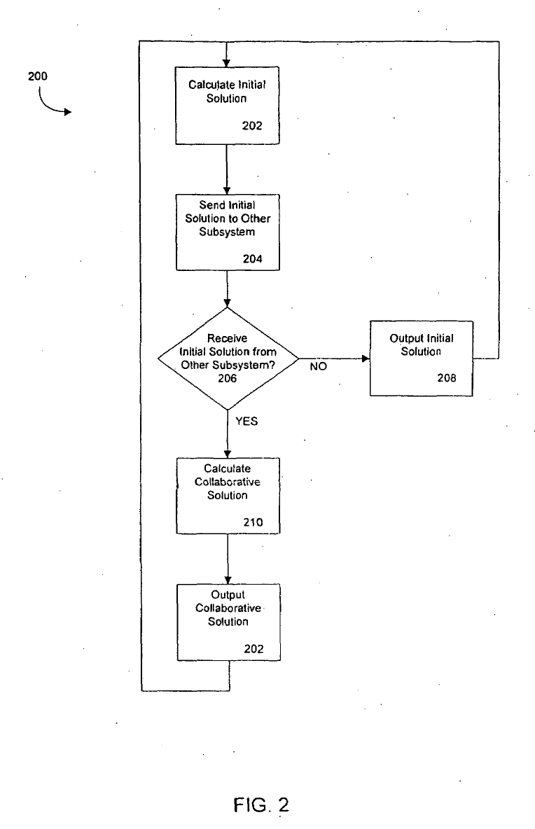

Referring now to FIG. 2, a flowchart of an exemplary collaborative GPS/INS method 200 according to various embodiments is shown. It is to be understood that this flowchart depicts the operation of a single GPS or INS subsystem. In a step 202, a GPS or INS subsystem calculates an initial solution. In a step 204, the GPS or INS subsystem sends the initial solution to one or more other GPS or INS subsystems. In a step 206, a determination is made whether the GPS or INS subsystem has received an initial solution from the one or more other GPS or INS subsystems and, if not, outputs the calculated initial solution in a step 208. Alternatively, if an initial solution was received from one or more other GPS or INS subsystems, then in a step 210 the GPS or INS subsystem calculates a collaborative solution based on the received initial solution. In a step 212 the collaborative solution is output and the process returns to step 202.

In testing, it was determined that a GPS subsystem with aiding INS solution information outputted continuous position and velocity solutions that were more accurate than a stand-alone GPS solution. An INS subsystem used for aiding in the testing was a low-cost unit with accuracy parameters as shown in the following Table 4:

TABLE 4
Aiding INS Accuracy Parameters

| | |
|---|---|
| Gyro | Accelerometer |

| Bias | Noise std | Bias | Noise std |
|---|---|---|---|
| 1000 deg/hr | 10 deg/sec | 50 mg | 1 m/s² |

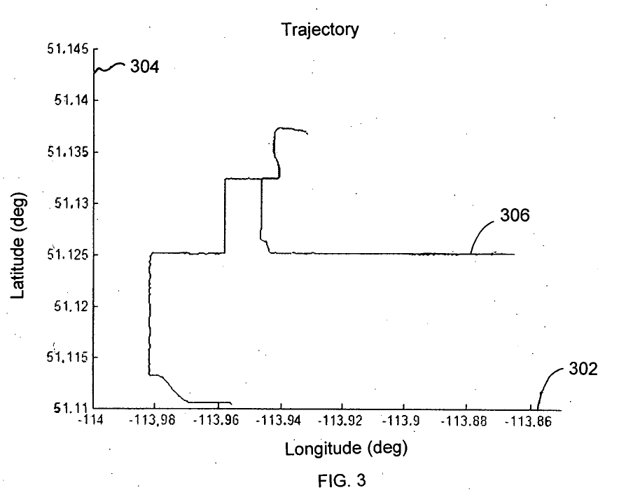

The testing was conducted on a vehicle driven for 1500 seconds. The trajectory of the drive is seen in FIG. 3 in graphical form with an x-axis 302 showing longitude, a y-axis 304 showing latitude, and the trajectory itself shown by graphed line 306 mapping a drive consisting of periods of high dynamics, periods of straight-line driving as well as changing vehicle speeds. The following Table 5 contains the drive test error statistics for the GPS only and Collaborative GPS/INS navigation solutions from known reference coordinates and speed.

TABLE 5
Error Statistics for 1500 s Drive Test

| | 3D RMS Position Errors | 3D RMS Velocity Errors |
|---|---|---|
| GPS | 4.64 m | 0.12 m/s |
| Collaborative GPS | 3.77 m | 0.12 m/s |
| Collaborative INS | 3.73 m | 0.12 m/s |

Even with a low-cost INS sub-system, this test shows that aiding improved the accuracy of the position portion of the navigation solution from 4.64 meters to less than 3.8 meters. Further, as mentioned elsewhere herein, the collaborative INS solution can be seen here to be similar to the collaborative GPS solution in accuracy.

When the GPS subsystem 140 is artificially constrained to see only four visible satellites, the minimum number necessary for the GPS subsystem 140 to generate a stand-alone navigation solution, the error statistics from the test are shown in the following Table 6:

TABLE 6
Error Statistics When Constrained to Four Visible GPS Satellites

| | 3D RMS Position | 3D RMS Velocity | Maximum 3D |
|---|---|---|---|
| | Errors | Errors | Position Errors |
| GPS | 10.00 m | 0.24 m/s | 31.86 m |
| Collaborative | 5.28 m | 0.25 m/s | 12.26 m |
| GPS | | | |
| Collaborative | 5.22 m | 0.25 m/s | 12.27 m |
| INS | | | |

While all three navigation solutions have degraded in this artificially constrained situation, the collaborative navigation solutions have degraded less and still remain comparable to the accuracy of the GPS only solution with no constraining of satellites. The maximum 3D position error is also much smaller when using aiding information.

Several embodiments are specially illustrated and/or described herein. However, it will be appreciated that modification and variations are covered by the above teachings and within the scope of the appended claims without departing from the spirit and intended scope thereof.

The embodiments discussed herein are illustrative of the present invention. As these embodiments of the present invention are described with reference to illustrations, various modifications or adaptations of the methods or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A method comprising:
calculating an initial INS solution in an INS subsystem;
calculating an initial GPS solution in a GPS subsystem;
sending the initial INS solution from the INS subsystem to the GPS subsystem;
sending the initial GPS solution from the GPS subsystem to the INS subsystem;
calculating a collaborative INS solution in the INS subsystem;
calculating a collaborative GPS solution in GPS subsystem;
outputting the collaborative INS solution from the INS subsystem;
outputting the collaborative GPS solution from the GPS subsystem.

2. The method of claim 1 wherein sending the initial INS solution uses a collaborative integration protocol.

3. The method of claim 1 wherein sending the initial GPS solution uses a collaborative integration protocol.

4. The method of claim 1 further comprising selecting the collaborative GPS solution as a primary navigation solution.

5. A method comprising:
calculating an initial INS solution in an INS subsystem;
calculating an initial GPS solution in a GPS subsystem;
sending the initial INS solution from the INS subsystem to the GPS subsystem;
sending the initial GPS solution from the GPS subsystem to the INS subsystem;
outputting the initial INS solution from the INS subsystem, if the INS subsystem does not receive the initial GPS solution from the GPS subsystem;
outputting the initial GPS solution from the GPS subsystem, if the GPS subsystem does not receive the initial INS solution from the INS subsystem;
calculating a collaborative INS solution in the INS subsystem and outputting the collaborative INS solution from the INS subsystem, if the INS subsystem does receive the initial GPS solution from the GPS subsystem;
calculating a collaborative GPS solution in GPS subsystem and outputting the collaborative GPS solution from the GPS subsystem, if the GPS subsystem does receive the initial INS solution from the INS subsystem.

6. The method of claim 5 wherein sending the initial INS solution uses a collaborative integration protocol.

7. The method of claim 5 wherein sending the initial GPS solution uses a collaborative integration protocol.

8. The method of claim 5 further comprising selecting the collaborative GPS solution as a primary navigation solution.

9. An apparatus comprising:
an INS subsystem configured to calculate an initial INS solution;
a GPS subsystem configured to calculate an initial GPS solution;
the INS subsystem further configured to send the initial INS solution to a GPS subsystem, and still further configured to calculate and output a collaborative INS solution based on an initial GPS solution received from the GPS subsystem;
the GPS subsystem further configured to send the initial GPS solution to the INS subsystem, and still further configured to calculate and output a collaborative GPS solution based on the initial INS solution received from the INS subsystem.

10. The apparatus of claim 9 wherein the INS subsystem configured to send the initial INS solution to the GPS subsystem is via a port.

11. The apparatus of claim 9 wherein the INS subsystem configured to send the initial INS solution to the GPS subsystem is via a collaborative integration protocol.

12. The apparatus of claim 9 wherein the GPS subsystem configured to send the initial GPS solution to the INS subsystem is via a port.

13. The apparatus of claim 9 wherein the GPS subsystem configured to send the initial GPS solution to the INS subsystem is via a collaborative integration protocol.

14. An apparatus comprising:
an INS subsystem configured to calculate an initial INS solution;
a GPS subsystem configured to calculate an initial GPS solution;
the INS subsystem further configured to send the initial INS solution to the GPS subsystem, and still further configured to calculate and output a collaborative INS solution if the INS subsystem receives an initial GPS solution from the GPS subsystem else output the initial INS solution;
the GPS subsystem further configured to send the initial GPS solution to the INS subsystem, and still further configured to calculate and output a collaborative GPS solution if the GPS subsystem receives the initial INS solution from the INS subsystem else output the initial GPS solution.

15. The apparatus of claim 14 wherein the INS subsystem further configured to send the initial INS solution to the GPS subsystem is via a port.

16. The apparatus of claim 14 wherein the INS subsystem further configured to send the initial INS solution to the GPS subsystem is via a collaborative integration protocol.

17. The apparatus of claim 14 wherein the GPS subsystem further configured to send the initial GPS solution to the INS subsystem is via a port.

18. The apparatus of claim 9 wherein the GPS subsystem further configured to send the initial GPS solution to the INS subsystem is via a collaborative integration protocol.
